(19) United States
(12) Patent Application Publication
(10) Pub. No.: US 2010/0182477 A1
(43) Pub. Date: Jul. 22, 2010

(54) SOLID-STATE IMAGING DEVICE

(75) Inventor: Kazuya Yonemoto, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/377,764

(22) PCT Filed: Aug. 10, 2007
(86) PCT No.: PCT/JP2007/065978

§ 371 Date: Feb. 17, 2009

(30) Foreign Application Priority Data
Aug. 29, 2006 (JP) 2006-232622

(51) Int. Cl. H04N 5/335

(52) U.S. Cl. 348/311; 348/E05.091

(57) ABSTRACT

In a solid-state imaging device, photodiodes (12) are classified into a plurality of fields, and each one of driving pulses (V1A, V1B, V2, V3A, V3B, V4) is applied to corresponding one of the photodiodes via a plurality of electrodes (17). Of the electrodes, a plurality of electrodes used to control readout of the signal charges from the photodiodes to the charge-coupled devices (11) are interconnected such that each one of a plurality of independent driving pulses (V1A, V1B, V3A, V3B) is applied to the corresponding one of the electrodes in accordance with the number of fields into which the photodiodes are classified.

### TECHNICAL FIELD

The present invention relates to a solid-state imaging device in which signal charges are read out using charge-coupled devices, and a method of driving the same.

### BACKGROUND ART

Solid-state imaging devices are widely used in which a plurality of signal charges obtained from a plurality of photodiodes arranged cyclically on a two-dimensional plane are transferred using vertical charge-coupled devices (VCCDs) each of which is placed in a separate column, and thereafter the signal charges are transferred using a horizontal charge-coupled device (HCCD: Horizontal CCD) to be outputted to the outside. Such solid-state imaging devices are also called CCD imaging devices.

FIG. 1 is a block diagram illustrating an exemplary structure of a conventional CCD imaging device 9 disclosed in Japanese Patent No. 3,277,974.

FIG. 2 is a diagram illustrating arrangement of control signal lines that are used to apply driving pulses V1 to V4 to VCCDs 11 in the CCD imaging device 9.

In the CCD imaging device 9, the control signal lines are twisted between the photodiodes so that alignment orders thereof alternate between columns. As a result, different patterns of driving pulses are applied to the VCCDs 11 depending on whether they are in odd-numbered columns or in even-numbered columns, so that the signal charges are transferred in opposite directions. Hereinafter, this type of transfer will be referred to simply as “two-way transfer”.

A horizontal charge-coupled device HCCD-b 13 shown in a lower part of FIG. 1 transfers only signal charges that are transferred from the odd-numbered VCCDs 11, whereas a horizontal charge-coupled device HCCD-t 14 shown in an upper part of FIG. 1 transfers only signal charges that are transferred from the even-numbered VCCDs 11.

The number of stages of the above two horizontal charge-coupled devices HCCD-b 13 and HCCD-t 14 is half the number of stages that would be required for a horizontal charge-coupled device which is used in a CCD imaging device in which the odd- and even-numbered vertical charge-coupled devices transfer the signal charges in the same direction and which transfers the signal charges from all the vertical charge-coupled devices.

Because of this, it is possible to reduce a driving frequency of the horizontal charge-coupled devices to half to suppress reduction in charge transfer efficiency, and achieve improved image quality while maintaining an output time. It is also possible to shorten the output time while maintaining the driving frequency.

### DISCLOSURE OF INVENTION

While the above conventional solid-state imaging device improves a trade-off between the image quality and the output time by the two-way transfer, its readout operation is limited to 2:1 interlace (see FIGS. 2A and 2B of Japanese Patent No. 3,277,974). That is, it is impossible to divide a frame into multiple fields utilizing multiple-to-one interlace for the readout and transfer of the signal charges.

The multiple-to-one interlace is a technique for increasing a saturation signal charge amount of the vertical charge-coupled devices to improve a dynamic range of an output signal, and is frequently used in solid-state imaging devices using a single horizontal charge-coupled device.

Because of an inability to adopt this technique, it is difficult to achieve improvement in dynamic range of the output signal and, more broadly, in image quality in the solid-state imaging device that performs the conventional two-way transfer.

The present invention has been devised in view of the above situation, and is conceived with an object to provide a technique for improving quality of an image to be obtained in a solid-state imaging device that performs the two-way transfer.

In order to achieve the aforementioned object, the solid-state imaging device of the present invention is a solid-state imaging device including: a plurality of photodiodes arranged cyclically on a plane; a plurality of control signal lines alignment orders of which alternate between columns; and a plurality of charge-coupled devices each of which is provided in a column, has a plurality of electrodes and reads out a plurality of signal charges obtained from the photodiodes as a result of a driving pulse being applied from one of the control signal lines to a corresponding one of the electrodes, so as to transfer the signal charges in a direction opposite to a direction of signal charge transfer performed by the charge-coupled devices in neighboring columns. In the solid-state imaging device, the photodiodes are classified into a plurality of fields, and of the electrodes, a plurality of electrodes used to control readout of the signal charges from the photodiodes to the charge-coupled devices are interconnected such that each of the independent driving pulses is applied to the corresponding one of the electrodes in accordance with the number of fields into which the photodiodes are classified, so that the signal charges in the photodiodes belonging to the respective fields are read out on a field-by-field basis.

Further, each of the charge-coupled devices may have first to fourth electrodes arranged cyclically to be driven by four-phase driving pulses, and the first and the third electrodes may both be electrically separated into groups that correspond in number to the number of fields into which the photodiodes are classified, and the electrodes separated into the respective groups may be connected to one another such that each of the independent driving pulses is applied to a corresponding one of the groups of the electrodes.

Furthermore, in each of the fields, each of the signal charges read out from the photodiodes to the charge-coupled devices may be divided in the charge-coupled device into a plurality of charge packets, and then each of the charge packets may be transferred.

In addition, preferably, when one of the signal charges has been read out to a part of the charge-coupled device corresponding to one of the groups of the first electrodes, the read-out signal charge may be divided into two equal charge packets at a part of the charge-coupled device corresponding to one of (i) an other one of the groups of the first electrodes that is not used for controlling the readout and (ii) one of the groups of the third electrodes that is not used for controlling the readout, and when one of the signal charges has been read out to a part of the charge-coupled device corresponding to an other one of the groups of the third electrodes, the read-out signal charge may be divided into two equal charge packets at a part of the charge-coupled device corresponding to one of (iii) the one of the groups of the third electrodes that is not used for controlling the readout and (iv) the other one of the groups of the first electrodes that is not used for controlling the readout. Then, the equally divided charge packets may be transferred in accordance with the four-phase driving pulses.

According to the above configuration, each of the signal charges can be divided in the charge-coupled device into the plurality of charge packets before being subjected to vertical transfer. Therefore, it is possible to increase the saturation signal charge amount compared to the conventional art, and obtain an image with a wide dynamic range.

Further, in each of the fields, each of the charge-coupled devices may transfer the read-out signal charges and noise charges that arise in parts of the charge-coupled device each of which is adjacent to a part used for transferring each signal charge so as to output the signal charges and the noise charges independently of each other, and may furthermore include a signal processing unit which corrects signal information representing an amount of the signal charges outputted, in accordance with noise information representing an amount of the noise charges outputted.

According to the above configuration, the noise that arises in the charge-coupled devices is cancelled. Therefore, it is possible to reduce noise, such as smear, that significantly arises in the charge-coupled devices to achieve remarkable improvement in image quality.

In addition, each cycle of the first to the fourth electrodes may be arranged in a part of the charge-coupled device that corresponds in size to one pixel, and moreover, the photodiodes in a column may be displaced from other ones of the photodiodes in a neighboring column.

According to the above configuration, it is possible to combine the two-way division transfer and interlace readout using a conventional progressive scan CCD imaging device, to achieve remarkable improvement in image quality.

The present invention can be implemented not only as the above-described solid-state imaging device but also as a solid-state imaging system and a camera that contain such a solid-state imaging device and a method of driving such a solid-state imaging device.

The solid-state imaging device according to the present invention includes a means for applying a plurality of independent driving pulses to a plurality of electrodes in accordance with the number of fields, when the interlace readout is performed with one frame classified into a plurality of fields. Accordingly, it is possible to divide each signal charge into a plurality of charge packets in the charge-coupled devices before vertical transfer. Therefore, it is possible to increase the saturation signal charge amount compared to the conventional art, and obtain an image with a wide dynamic range.

In the case where each signal charge is not divided into the charge packets, it is possible to transfer the noise charges using empty charge packets to be outputted independently. Therefore, it is possible to achieve remarkable improvement in image quality by correcting desired signal information using noise information outputted in accordance with the noise charges.

### FURTHER INFORMATION ABOUT TECHNICAL BACKGROUND TO THIS APPLICATION

The disclosure of Japanese Patent Application No. 2006-232622 filed on Aug. 29, 2006 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating an exemplary structure of a conventional CCD imaging device;

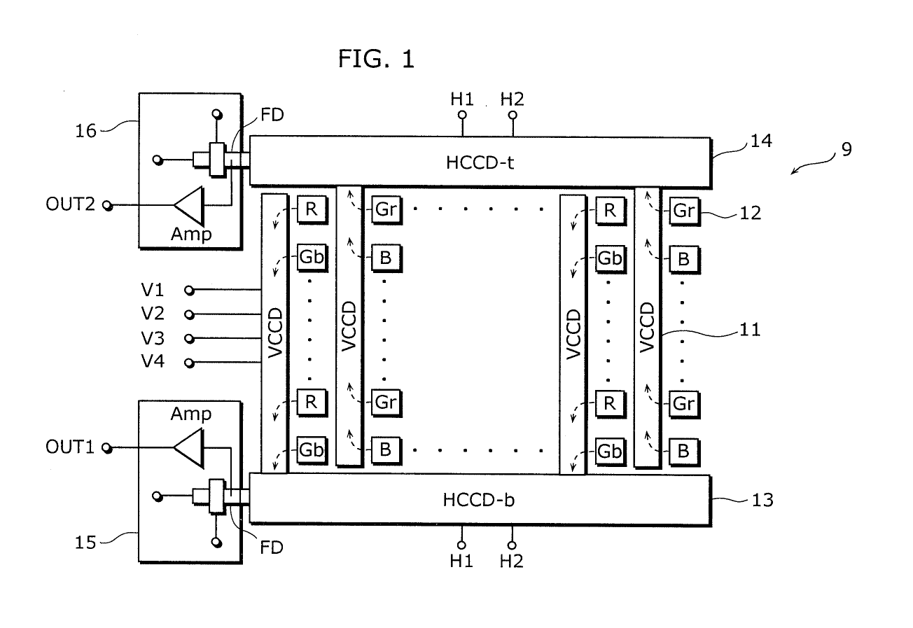

FIG. 2 is a diagram illustrating arrangement of control signal lines used in the conventional CCD imaging device;

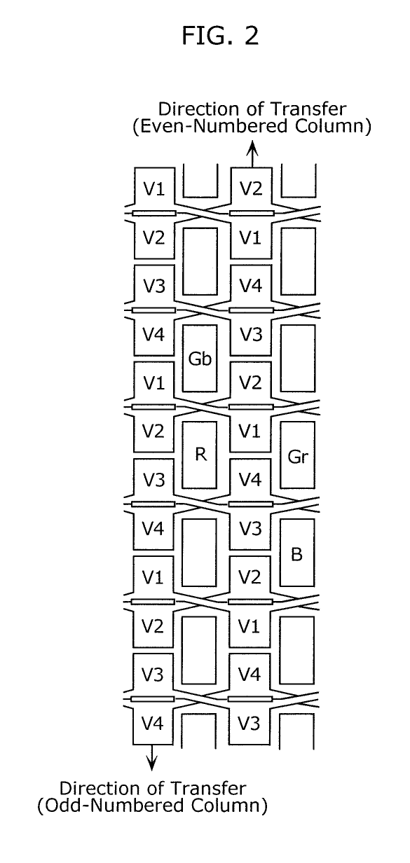

FIG. 3 is a block diagram illustrating an exemplary functional structure of a CCD imaging device according to one embodiment of the present invention;

FIG. 4 is a diagram illustrating an exemplary layout of the CCD imaging device;

FIGS. 5A and 5B are diagrams illustrating exemplary variation of potential distributions over time in vertical CCDs;

FIGS. 6A to 6D are diagrams illustrating exemplary timing of driving pulses;

FIG. 7 is a diagram illustrating an exemplary layout of another CCD imaging device;

FIGS. 8A and 8B are diagrams illustrating other exemplary timing of the driving pulses;

FIGS. 9A and 9B are diagrams illustrating other exemplary to variation of the potential distributions over time in the vertical CCDs;

FIG. 10 is a block diagram illustrating an exemplary structure of a signal processing system for smear correction; and

FIGS. 11A and 11B are diagrams illustrating exemplary layouts of other CCD imaging devices.

### BEST MODE FOR CARRYING OUT THE INVENTION

Hereinafter, a CCD imaging device according to one embodiment of the present invention will be described in detail with reference to the accompanying drawings.

<Structure of CCD Imaging Device>

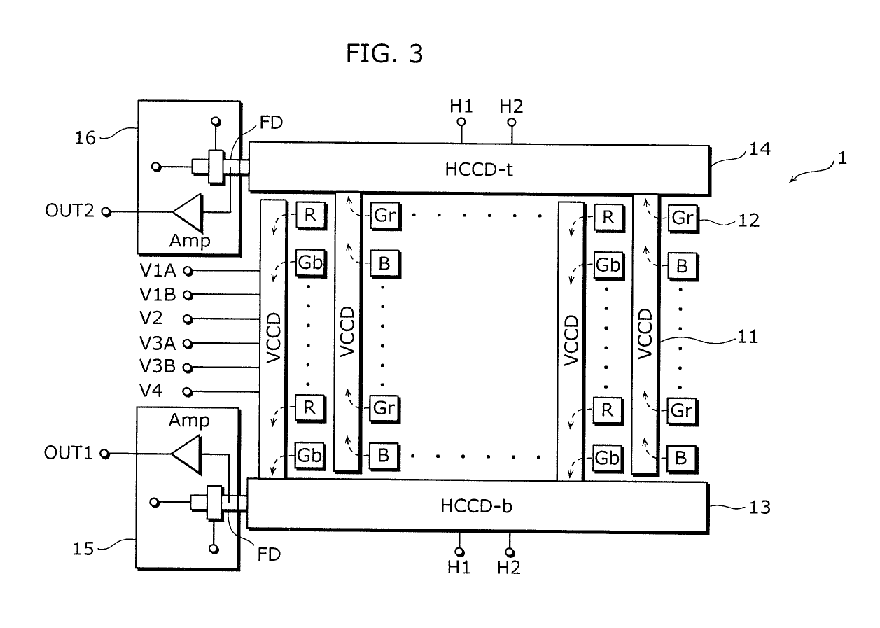

FIG. 3 is a block diagram illustrating an exemplary functional structure of a CCD imaging device 1 according to one embodiment of the present invention.

The CCD imaging device 1 includes an imaging area having vertical CCDs 11, which are represented by vertically oriented rectangles labeled “VCCD”, and photodiodes 12, which are represented by squares labeled “R”, “Gr”, “Gb”, or “B”. In the imaging area, odd-numbed (counting from the left) vertical CCDs transfer signal charges from the photodiodes in a downward direction, whereas even-numbered vertical CCDs transfer the signal charges from the photodiodes in an upward direction.

A horizontal CCD 13 and a horizontal CCD 14 are arranged below and above the imaging area, respectively. Signals outputted from left ends of the horizontal CCDs 13 and 14 are inputted to floating diffusion amplifiers 15 and 16, each including a floating diffusion unit FD and a readout amplifier Amp. As a result, signals in pixels belonging to the odd- and even-numbered vertical CCDs 11 are outputted via output terminals OUT1 and OUT2, respectively.

The CCD imaging device 1 has a similar structure to a CCD imaging device that performs a conventional two-way transfer, but in order to achieve 4:1 interlace, a plurality of electrodes (referred to as “first-phase electrodes”) to which a driving pulse V1 would be applied in conventional vertical CCDs are electrically separated into two groups, to one of which an independent driving pulse V1A is applied and to the other one of which an independent driving pulse V1B is applied. In addition, a plurality of electrodes (referred to as “third-phase electrodes”) to which a driving pulse V3 would be applied in the conventional vertical CCDs are electrically separated into two groups, to one of which an independent driving pulse V3A is applied and to the other one of which an independent driving pulse V3B is applied. Electrodes that belong to the same group are connected to each other so that an independent driving pulse is applied to each electrode in the same group. The CCD imaging device 1 is different from a conventional CCD imaging device in the above respects.

Here, the 4:1 interlace refers to a technique of classifying all photodiodes into four fields, and reading out signal charges in photodiodes that belong to the same field at a time, and one field after another, so that the signal charges in all the photodiodes, i.e., information of one frame, will be read out on a field-by-field basis.

Symbols written in the squares representing the photodiodes denote exemplary types of color filters provided at the photodiodes, with “R” denoting a red filter, “B” denoting a blue filter, and “Gr” and “Gb” denoting a green filter that is in the same row as “R” and “B”, respectively. Hereinafter, the symbols for the color filters will be used, as necessary, to refer to the photodiodes at which the respective color filters are provided.

Curved arrows that extend from the photodiodes 12 to the vertical CCDs indicate a direction in which the signal charges are read out and transferred from the photodiodes.

The horizontal CCDs 13 and 14 are two-phase CCDs, and driven by control pulses applied to terminals H1 and H2.

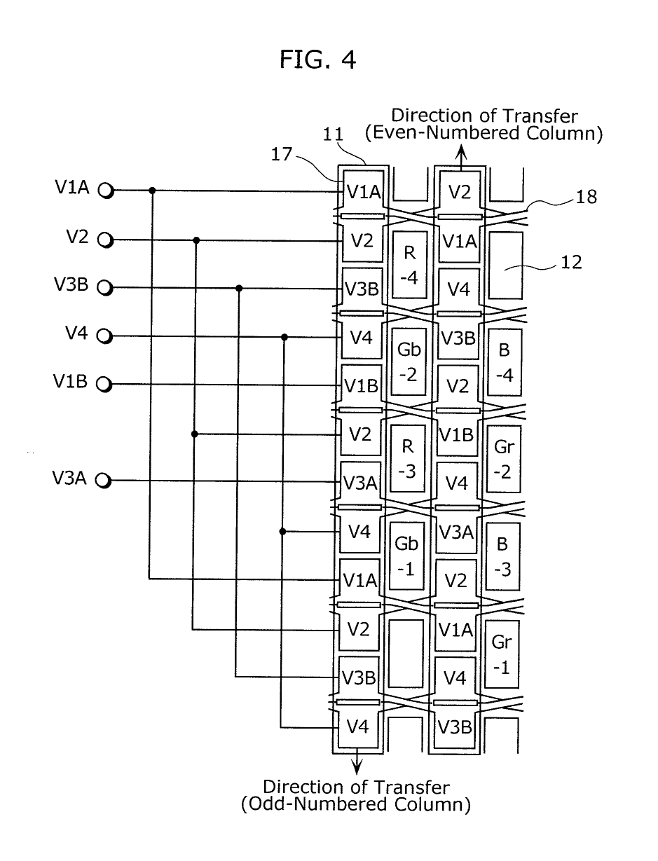

FIG. 4 is a diagram illustrating an exemplary layout of electrodes 17 of the vertical CCDs 11, the photodiodes 12, and control signal lines 18 in the CCD imaging device 1.

The electrodes of the vertical CCDs 11 are basically configured to be capable of being four-phase driven, as described in Japanese Patent No. 3,277,974 mentioned in the Background Art section. In addition, in order to achieve the 4:1 interlace in readout and transfer of the signal charges from the photodiodes 12 to the vertical CCDs 11, the conventional first-phase electrodes are electrically separated into the two groups, to one of which the independent driving pulse V1A is applied and to the other one of which the independent driving pulse V1B is applied, whereas the conventional third-phase electrodes are electrically separated into the two groups, to one of which the independent driving pulse V3A is applied and to the other one of which the independent driving pulse V3B is applied. Driving pulses V2 and V4 are applied to second-phase electrodes and fourth-phase electrodes, respectively, as in the conventional art.

<Operation of CCD Imaging Device>

Next, an operation of the vertical CCDs 11 in the above CCD imaging device 1 will now be described below.

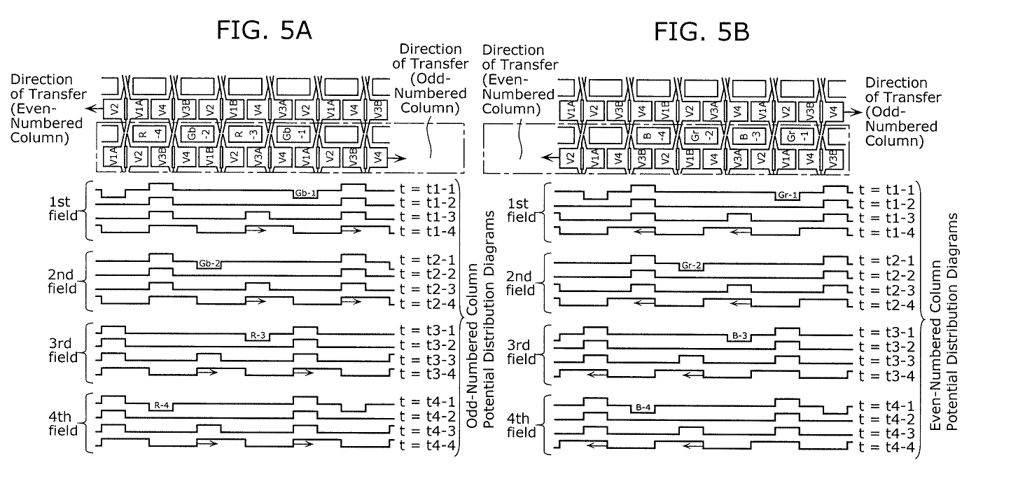

FIGS. 5A and 5B are diagrams illustrating examples of specific potential distributions in the odd- and even-numbered columns, respectively, when the signal charges are read out from the photodiodes 12 to the vertical CCDs 11 and each divided into two equal charge packets, and thereafter the transfer by the vertical CCDs 11 is started in each field.

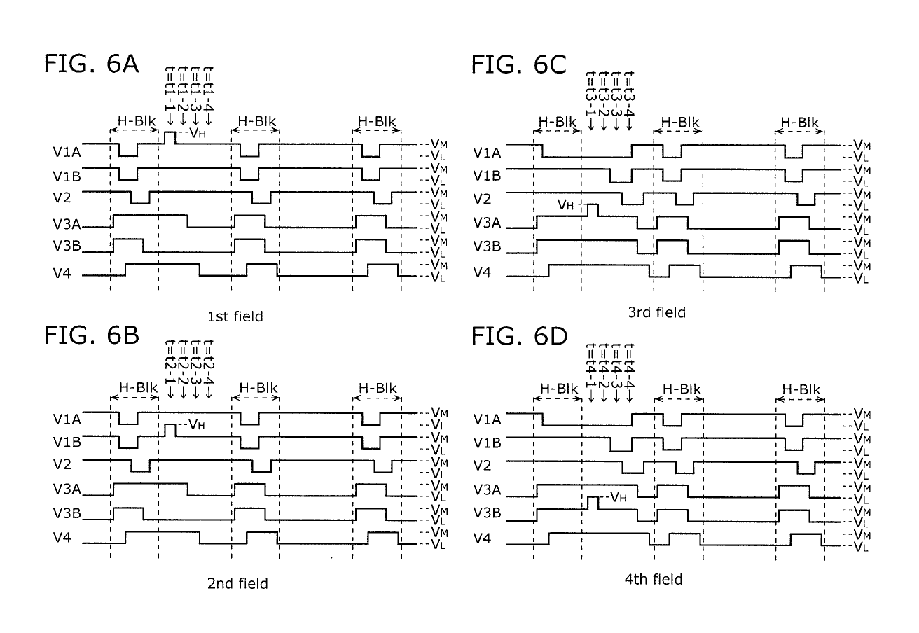

FIGS. 6A to 6D are diagrams illustrating exemplary timing of the driving pulses in first to fourth fields, respectively.

Hereinafter, the electrodes to which the driving pulses V1A, V1B, V2, V3A, V3B, and V4 are applied will be referred to, as necessary, by names of their respective driving pulses.

With reference to FIGS. 6A to 6D, a basic operation of the 4:1 interlace in the CCD imaging device 1 will now be described below. Here, the 4:1 interlace refers to an operation of reading out the signal charges from the photodiodes 12 on a field-by-field basis, while all photodiodes 12 are classified into the four fields by associating each of the photodiodes 12 with one of the four fields.

First, in the first field of the 4:1 interlace, as a result of a level of the driving pulse applied to electrodes V1A becoming a level V_{H} (a time t1-1 in FIG. 6A), signal charges in photodiodes Gb-1 in odd-numbered columns and signal charges in photodiodes Gr-1 in even-numbered columns are read out to their respective vertical CCDs 11.

In a subsequent horizontal blanking period (a period denoted by “H-Blk” in FIG. 6A), a driving pulse equal to the conventional driving pulse V1 is applied to both the electrodes VIA and the electrodes V1B, and a driving pulse equal to the conventional driving pulse V3 is applied to both the electrodes V3A and the electrodes V3B. As a result, the transfer of the signal charges is carried out within the vertical CCDs in accordance with driving pulses equal to conventional four-phase driving pulses.

The same is true with the second to fourth fields as well. In the second field, as a result of a level of the driving pulse applied to the electrodes V1B becoming the level V_{H} (a time t2-1 in FIG. 6B), the signal charges in the photodiodes Gb-2 and Gr-2 are read out to their respective vertical CCDs 11 to be transferred.

In the third field, as a result of a level of the driving pulse applied to the electrodes V3A becoming the level V_{H} (a time t3-1 in FIG. 6C), the signal charges in photodiodes R-3 and B-3 are read out to their respective vertical CCDs 11 to be transferred.

In the fourth field, as a result of a level of the driving pulse applied to the electrodes V3B becoming the level V_{H} (a time t4-1 in FIG. 6D), the signal charges in photodiodes R-4 and B-4 are read out to their respective vertical CCDs 11 to be transferred.

In the CCD imaging device 1, the following characteristic operation is performed in addition to the above basic operation of the 4:1 interlace. Specifically, in each field, the signal charges read out from the photodiodes to the vertical CCDs 11 are each divided into two equal charge packets in four-phase drive before being subjected to vertical transfer. This operation will now be described in detail below with reference to FIGS. 5A and 5B.

In the first field, immediately before the time t1-1, a voltage V_{L} is applied to the electrodes V3B while a voltage V_{M} is applied to the other electrodes. Then, when a voltage V_{H} is applied to the electrodes VIA at the time t1-1, the signal charges are read out from the photodiodes Gb-1 in the odd-numbered columns and the photodiodes Gr-1 in the even-numbered columns to the vertical CCDs 11. That is, in the first field, the electrodes V1A are used to control the readout of the signal charges.

At a time t1-2, parts corresponding to the electrodes V3B serve as potential barriers to allow the read-out signal charges to be accumulated in a series of parts corresponding to the electrodes V4, V1A, V2, V3A, V4, V1B, and V2.

Thereafter, when a voltage applied to the electrodes V3A is changed to V_{L} at a time t1-3, the signal charges read out from the photodiodes Gr-1 or Gb-1 are each divided into the two equal charge packets, one accumulated in a part corresponding to the electrodes V4, V1A, and V2, and the other in a part corresponding to the electrodes V4, V1B, and V2.

Then, at a time t1-4, a voltage applied to the electrodes V4 is changed from V_{M} to V_{L}. Hereafter, a vertical transfer operation according to conventional four-phase drive is carried out, so that the signal charges from the photodiodes Gb-1 in the odd-numbered columns and the signal charges from the photodiodes Gr-1 in the even-numbered columns are transferred by the vertical CCDs 11.

Then, referring to FIG. 3 again, the signal charges from the photodiodes Gb-1 in the odd-numbered columns are further transferred by the horizontal CCD 13, whereas the signal charges from the photodiodes Gr-1 in the even-numbered columns are further transferred by the horizontal CCD 14.

As a result, in the first field, signal information representing the amount of the signal charges in the photodiodes Gb-1 is outputted via the OUT1, whereas signal information representing the amount of the signal charges in the photodiodes Gr-1 is outputted via the OUT2.

In the second field, the electrodes V1B are used to control the readout of the signal charges. Immediately before the time t2-1, the voltage V_{L} is applied to the electrodes V3B, and at the time t2-1, the voltage V_{H} is applied to the electrodes V1B. As a result, the signal charges in the photodiodes Gb-2 in the odd-numbered columns and the signal charges in the photodiodes Gr-2 in the even-numbered columns are read out to the vertical CCDs.

Thereafter, when the voltage applied to the electrodes V3A is changed to V_{L} at a time t2-3, the read-out signal charges are each divided into two charge packets. The divided signal charges are transferred in accordance with the operation according to the conventional four-phase drive as in the first field.

As a result, in the second field, signal information representing the amount of the signal charges in the photodiodes Gb-2 is outputted via the OUT1, whereas signal information representing the amount of the signal charges in the photodiodes Gr-2 is outputted via the OUT2.

In the third field, the electrodes V3A are used to control the readout of the signal charges. Immediately before the time t3-1, the voltage V_{L} is applied to the electrodes V1A, and at the time t3-1, the voltage V_{H} is applied to the electrodes V3A. As a result, the signal charges in the photodiodes R-3 in the odd-numbered columns and the signal charges in the photodiodes B-3 in the even-numbered columns are read out to the vertical CCDs.

Thereafter, when a voltage applied to the electrodes V1B is changed to V_{L} at a time t3-3, the read-out signal charges are each divided into two charge packets. The divided signal charges are transferred in accordance with the operation according to the conventional four-phase drive as in the first field.

As a result, in the third field, signal information representing the amount of the signal charges in the photodiodes R-3 is outputted via the OUT1, whereas signal information representing the amount of the signal charges in the photodiodes B-3 is outputted via the OUT2.

In the fourth field, the electrodes V3B are used to control the readout of the signal charges. Immediately before the time t4-1, the voltage V_{L} is applied to the electrodes V1A, and at the time t4-1, the voltage V_{H} is applied to the electrodes V3B. As a result, the signal charges in the photodiodes R-4 in the odd-numbered columns and the signal charges in the photodiodes B-4 in the even-numbered columns are read out to the vertical CCDs.

Thereafter, when the voltage applied to the electrodes V1B is changed to V_{L} at a time t4-3, the read-out signal charges are each divided into two charge packets. The divided signal charges are transferred in accordance with the operation according to the conventional four-phase drive as in the first field.

As a result, in the fourth field, signal information representing the amount of the signal charges in the photodiodes R-4 is outputted via the OUT1, whereas signal information representing the amount of the signal charges in the photodiodes B-4 is outputted via the OUT2.

In accordance with the above-described operation, the signal charge read out from each photodiode 12 is divided into the two equal charge packets in the vertical CCD 11 and subjected to the vertical transfer. Since these two charge packets correspond to charge packets that have conventionally transferred signal charges read out from separate photodiodes, approximately twice a saturation signal charge amount in the conventional art is obtained, and an image with a wide dynamic range can be obtained.

Note that although it has been assumed in the foregoing description that each of the electrodes V1 and V3 used to control the readout of the signal charges is classified into two groups, it is needless to say, the electrodes V1 and V3 may be classified into more than two groups so that independent driving pulses are applied to the electrodes belonging to the respective groups.

This makes it possible to provide more fields for interlace readout, and, in each of the fields, divide the signal charge read out from a single photodiode into a larger number of charge packets for transfer. Therefore, a still greater saturation signal charge amount can be obtained, and an image with a wide dynamic range can be obtained.

<Exemplary Application to Progressive Scan CCD Imaging Device>

Four-phase vertical CCDs in which one cycle of electrode pattern is provided for every two pixels have been described above. However, the same technique can be applied to four-phase vertical CCDs, such as progressive scan CCDs frequently used in a broadcasting service or the like, in which one cycle of electrode pattern is provided for each pixel, so that interlace readout can be performed using larger charge packets than in the conventional art.

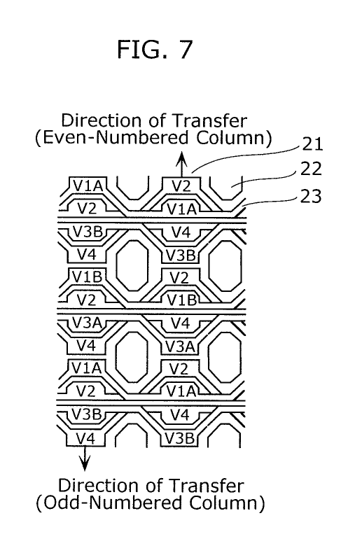

FIG. 7 shows an exemplary layout of electrodes 21, photodiodes 22, and control signal lines 23 in typical progressive scan CCDs.

It is assumed here that electrodes V1 and V3 are used as electrodes for controlling the readout of the signal charges and 2:1 interlace readout is performed using these progressive scan CCDs. To do this, the electrodes V1 are electrically separated into electrodes VIA in odd-numbered rows and electrodes V1B in even-numbered rows, and the electrodes V3 are electrically separated into electrodes V3A in the odd-numbered rows and electrodes V3B in the even-numbered rows, and independent driving pulses are applied to the electrodes belonging to the respective groups.

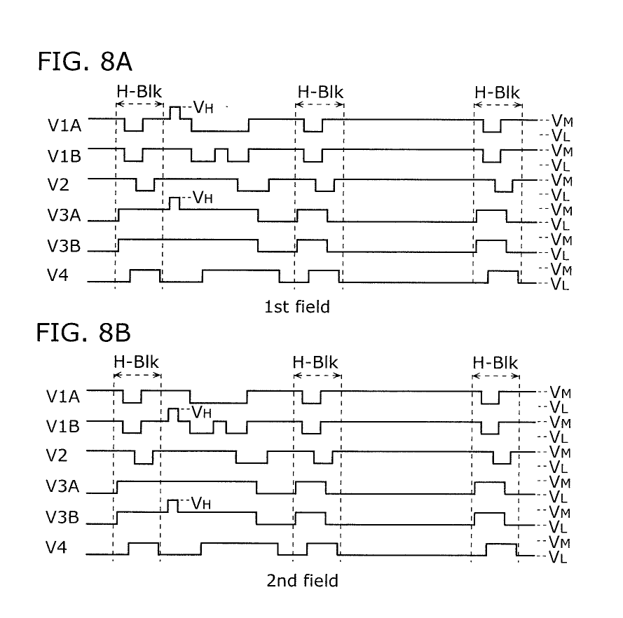

FIGS. 8A and 8B are diagrams illustrating exemplary timing of the driving pulses in the first and second fields, respectively. A concept of the readout of the signal charges and division thereof into equal parts in accordance with these driving pulses is similar to the above-described concept. Therefore, detailed description thereof is omitted.

Note that it has been assumed in the foregoing description that each of the electrodes V1 and V3 used for controlling the readout of the signal charges is classified into two groups. However, needless to say, the electrodes V1 and V3 may be classified into more than two groups, so that independent driving pulses are applied to the electrodes belonging to the respective groups.

This makes it possible to provide more fields for interlace readout, and, in each of the fields, divide the signal charge read out from a single photodiode into a larger number of charge packets for transfer. Therefore, a still greater saturation signal charge amount can be obtained, and an image with a wide dynamic range can be obtained.

<Exemplary Variant that Performs Smear Correction>

With FIGS. 5A and 5B, an exemplary case where each of the signal charges read out from the photodiodes is divided into two packets for transfer has been described. However, it may be so arranged that one of the two packets is used to transfer the signal charge, while the other packet is transferred in an empty state. This makes it possible to allow noise charges that arise in the vertical CCDs to be collected in the empty packets, so that signal information that represent the amount of the signal charges and noise information that represent the amount of the noise charges collected in the empty packets will be outputted independently of each other.

In this case, in subsequent camera signal processing, the signal information can be corrected using the noise information to reduce image degradation owing to the noise charges that arise in the vertical CCDs, thereby improving image quality of an image to be obtained from a camera. An exemplary specific method of this correction is to subtract a noise amount represented by the noise information from a signal amount represented by the signal information. This considerably reduces smear which is caused by the noise charges, for example.

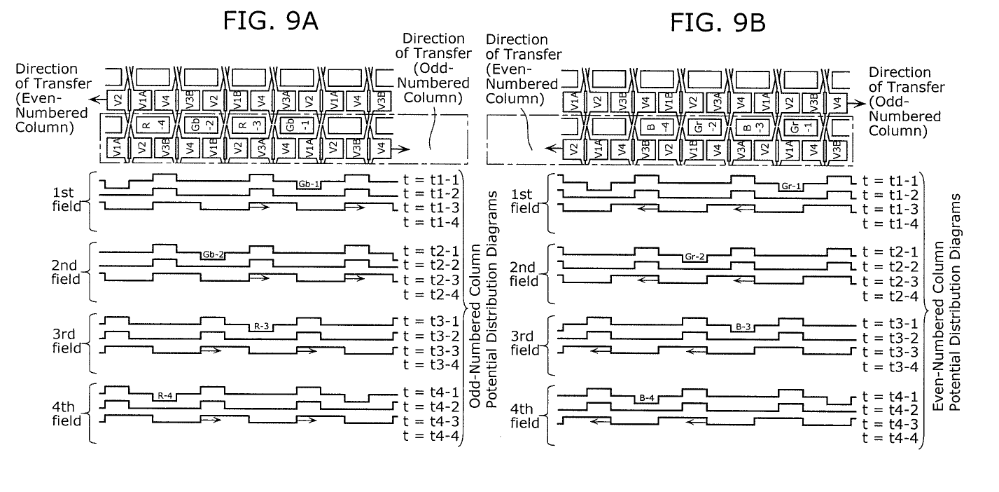

FIGS. 9A and 9B are diagrams illustrating exemplary potential distributions during the readout operation with respect to the odd-numbered columns and the even-numbered columns, respectively. Since timing of driving pulses corresponding to FIGS. 9A and 9B can be easily known by comparing these potential distribution diagrams and FIGS. 5A, 5B, and 6A to 6D, description thereof is omitted here.

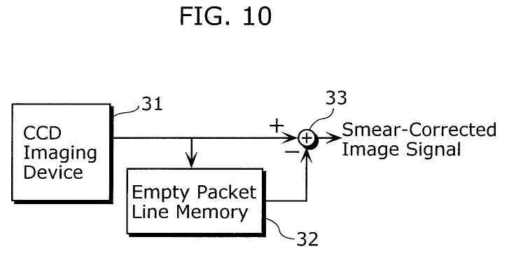

FIG. 10 is a block diagram illustrating an exemplary structure of a signal processing system for smear correction, which is an example of correcting the signal information using the noise information. As shown in FIG. 10, this system includes a CCD imaging device 31, and an empty packet line memory 32 and an operation unit 33 external to the CCD imaging device 31. The empty packet line memory 32 stores the noise information outputted from the CCD imaging device 31. The operation unit 33 subtracts the noise amount represented by the noise information stored in the empty packet line memory 32 from the signal amount represented by the signal information, which is outputted from the CCD imaging device 31 after the noise information.

Note that it has been assumed in the above description that the empty packet line memory 32 and the operation unit 33 are external to the CCD imaging device 31, but the empty packet line memory 32 and the operation unit 33 may naturally be formed on the same semiconductor substrate as the CCD imaging device 31.

<Exemplary Application to CCD Imaging Device in which Photodiodes are Displaced from Other Photodiodes in Neighboring Columns>

The techniques described above are also applicable to a CCD imaging device in which the photodiodes are displaced from other photodiodes in neighboring columns.

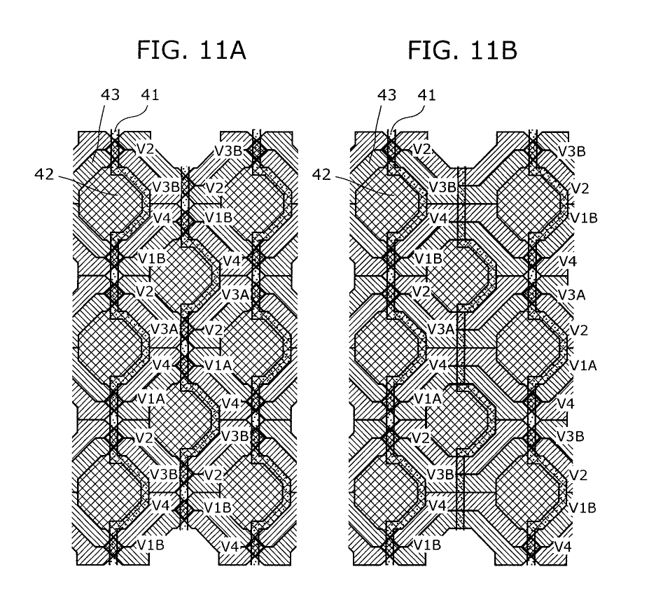

FIGS. 11A and 11B are diagrams illustrating exemplary layouts of insulating areas 41 that separate vertical CCDs in neighboring columns, photodiodes 42, and control signal lines 43 in such a CCD imaging device. In these structures shown, areas between the insulating areas 41 are the vertical CCDs, and areas where the control signal lines 43 and the vertical CCDs intersect function as the electrodes described above.

These structures are structures of one exemplary variation of the four-phase vertical CCDs in which one cycle of electrode pattern is provided for each pixel as in the progressive scan CCD imaging device described above with reference to FIGS. 7 and 8A and 8B, and differ from that of the above-described progressive scan CCD imaging device in that the photodiodes are displaced from other photodiodes in neighboring columns.

It is assumed here that electrodes V1 and V3 are used as electrodes for controlling the readout of the signal charges and the 2:1 interlace readout is performed using these progressive scan CCDs. To do this, the electrodes V1 are electrically separated into electrodes V1A in one of two rows adjacent to each other and electrodes V1B in the other one of the two rows adjacent to each other, and the electrodes V3 are electrically separated into electrodes V3A in one of two rows adjacent to each other and electrodes V3B in the other one of the two rows adjacent to each other, and independent driving pulses are applied to the electrodes belonging to the respective groups.

FIG. 11A illustrates an exemplary structure in which the alignment orders of the control signal lines 43 alternate every column. According to this structure, the vertical CCDs adjacent to each other can transfer the signal charges read out from the photodiodes in directions opposite to each other, and the 2:1 interlace readout can be performed.

FIG. 11B illustrates an exemplary structure in which the alignment orders of the control signal lines 43 alternate every other column. According to this structure, the vertical CCD in a column can transfer the signal charges read out from the photodiodes in the direction opposite to another vertical CCD in every other column, and the 2:1 interlace readout can be performed.

Whichever of the above structures is adopted, it is possible to combine the two-way transfer and the interlace readout, resulting in considerable improvement in quality of an image to be obtained.

Note that in these structures as well, each of the electrodes V1 and V3 may be classified into more than two groups.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a CCD imaging device, to and can be widely used in information appliances having an imaging capability, such as a video camera, a still camera, a portable information terminal, and the like.

1. A solid-state imaging device comprising:
a plurality of photodiodes arranged cyclically on a plane;
a plurality of control signal lines alignment orders of which alternate between columns; and
a plurality of charge-coupled devices each of which is provided in a column, has a plurality of electrodes and reads out a plurality of signal charges obtained from said photodiodes as a result of a driving pulse being applied from one of said control signal lines to a corresponding one of the electrodes, so as to transfer the signal charges in a direction opposite to a direction of signal charge transfer performed by said charge-coupled devices in neighboring columns,
wherein said photodiodes are classified into a plurality of fields, and
of the electrodes, a plurality of electrodes used to control readout of the signal charges from said photodiodes to said charge-coupled devices are interconnected such that each of the independent driving pulses is applied to the corresponding one of the electrodes in accordance with the number of fields into which said photodiodes are classified, so that the signal charges in said photodiodes belonging to the respective fields are read out on a field-by-field basis.

2. The solid-state imaging device according to claim 1,
wherein each of said charge-coupled devices has first to fourth electrodes arranged cyclically to be driven by four-phase driving pulses, and
the first and the third electrodes are both electrically separated into groups that correspond in number to the number of fields into which said photodiodes are classified, and the electrodes separated into the respective groups are connected to one another such that each of the independent driving pulses is applied to a corresponding one of the groups of the electrodes.

3. The solid-state imaging device according to claim 2,
wherein in each of the fields, each of the signal charges read out from said photodiodes to said charge-coupled devices is divided in said charge-coupled device into a plurality of charge packets, and then each of the charge packets is transferred.

4. The solid-state imaging device according to claim 3,
wherein when one of the signal charges has been read out to a part of said charge-coupled device corresponding to one of the groups of the first electrodes, the read-out signal charge is divided into two equal charge packets at a part of said charge-coupled device corresponding to one of (i) an other one of the groups of the first electrodes that is not used for controlling the readout and (ii) one of the groups of the third electrodes that is not used for controlling the readout,
when one of the signal charges has been read out to a part of said charge-coupled device corresponding to an other one of the groups of the third electrodes, the read-out signal charge is divided into two equal charge packets at a part of said charge-coupled device corresponding to one of (iii) the one of the groups of the third electrodes that is not used for controlling the readout and (iv) the other one of the groups of the first electrodes that is not used for controlling the readout, and
the equally divided charge packets are transferred in accordance with the four-phase driving pulses.

5. The solid-state imaging device according to claim 2,
wherein in each of the fields, each of said charge-coupled devices transfers the read-out signal charges and noise charges that arise in parts of said charge-coupled device each of which is adjacent to a part used for transferring each signal charge so as to output the signal charges and the noise charges independently of each other.

6. The solid-state imaging device according to claim 2,
wherein each cycle of the first to the fourth electrodes is arranged in a part of said charge-coupled device that corresponds in size to one pixel.

7. The solid-state imaging device according to claim 6,
wherein in each of the fields, each of said charge-coupled devices transfers the read-out signal charges and noise charges that arise in parts of said charge-coupled device each of which is adjacent to a part used for transferring each signal charge so as to output the signal charges and the noise charges independently of each other, and
said solid-state imaging device further comprises a signal processing unit operable to correct signal information representing an amount of the signal charges outputted, in accordance with noise information representing an amount of the noise charges outputted.

8. The solid-state imaging device according to claim 6,
wherein said photodiodes in a column are displaced from other ones of said photodiodes in a neighboring column.

9. A solid-state imaging system comprising the solid-state imaging device according to claim 1.

10. A camera comprising the solid-state imaging device according to claim 1.

11. A method for driving a solid-state imaging device comprising:
a plurality of photodiodes arranged cyclically on a plane;
a plurality of control signal lines alignment orders of which alternate between columns; and
a plurality of charge-coupled devices each of which is provided in a column, has a plurality of electrodes and reads out a plurality of signal charges obtained from the photodiodes as a result of a driving pulse being applied from one of the control signal lines to a corresponding one of the electrodes, so as to transfer the signal charges in a direction opposite to a direction of signal charge transfer performed by the charge-coupled devices in neighboring columns,
wherein each of the charge-coupled devices has first to fourth electrodes arranged cyclically to be driven by four-phase driving pulses,
said method comprising:
wherein when one of the signal charges has been read out to a part of said charge-coupled device corresponding to one of the groups of the first electrodes, dividing the read-out signal charge into two equal charge packets at a part of said charge-coupled device corresponding to one of (i) an other one of the groups of the first electrodes that is not used for controlling the readout and (ii) one of the groups of the third electrodes that is not used for controlling the readout,
when one of the signal charges has been read out to a part of said charge-coupled device corresponding to an other one of the groups of the third electrodes, dividing the read-out signal charge into two equal charge packets at a part of said charge-coupled device corresponding to one of (iii) the one of the groups of the third electrodes that is not used for controlling the readout and (iv) the other one of the groups of the first electrodes that is not used for controlling the readout, and
transferring the equally divided charge packets by applying the four-phase driving pulses.

12. A method of driving a solid-state imaging device comprising:
a plurality of photodiodes arranged cyclically on a plane;
a plurality of control signal lines alignment orders of which alternate between columns; and
a plurality of charge-coupled devices each of which is provided in a column, has a plurality of electrodes and reads out a plurality of signal charges obtained from the photodiodes as a result of a driving pulse being applied from one of the control signal lines to a corresponding one of the electrodes, so as to transfer the signal charges in a direction opposite to a direction of signal charge transfer performed by the charge-coupled devices in neighboring columns,
wherein each of the charge-coupled devices has first to fourth electrodes arranged cyclically to be driven by four-phase driving pulses,
said method comprising:
transferring the signal charges read out by each of the charge-coupled devices in each field; and
transferring noise charges that arise in parts of the charge-coupled device each of which is adjacent to a part used for transferring each signal charge by the charge-coupled device.

13. The method of driving the solid-state imaging device according to claim 12, further comprising
correcting signal information representing an amount of the signal charges transferred, in accordance with noise information representing an amount of the noise charges transferred.
